(19) United States
(12) Patent Application Publication
(10) Pub. No.: US 2025/0254599 A1
(43) Pub. Date: Aug. 7, 2025

(54) SYSTEMS AND METHODS FOR DEVICE-TO-DEVICE COMMUNICATIONS

(71) Applicant: ZTE CORPORATION, Shenzhen (CN)

(72) Inventors: Mengzhen WANG, Shenzhen (CN); Lin CHEN, Shenzhen (CN); Wanfu XU, Shenzhen (CN); Tao QI, Shenzhen (CN)

(73) Assignee: ZTE CORPORATION, Shenzhen (CN)

(21) Appl. No.: 19/169,760

(22) Filed: Apr. 3, 2025

Related U.S. Application Data
(63) Continuation of application No. PCT/CN2022/125391, filed on Oct. 14, 2022.

(51) Int. Cl. H04W 40/22; H04W 88/06

(52) U.S. Cl. CPC H04W 40/22; H04W 88/06

(57) ABSTRACT

In some arrangements, a first BS (source BS) sends to a second BS (target BS) a handover request including a target cell ID. A remote UE is communicating with the first BS via a first indirect path including a first SL between the remote UE and a first relay UE or a first direct path between the remote UE and the first BS. The target cell ID includes an ID of a serving cell (e.g., serving cell ID or NCGI) of a second relay UE or a serving cell of the direct path. The first BS receives from the second BS a handover response.

### CROSS-REFERENCE TO RELATED APPLICATION

This application claims the benefit of priority under 35 U.S.C. § 120 as a continuation of PCT Patent Application No. PCT/CN2022/125391, filed on Oct. 14, 2022, the disclosure of which is incorporated herein by reference in its entirety.

### TECHNICAL FIELD

The disclosure relates generally to wireless communications and, more particularly, to an anomaly state in device-to-device communications.

### BACKGROUND

Sidelink (SL) communication refers to wireless radio communication between two or more User Equipments (UEs). In this type of communications, two or more UEs that are geographically proximate to each other can communicate without being routed to a Base Station (BS) or a core network. Data transmissions in SL communications are thus different from typical cellular network communications that include transmitting data to a BS and receiving data from a BS. In SL communications, data is transmitted directly from a source UE to a target UE through, for example the Unified Air Interface (e.g., PC5 interface) without passing through a BS.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, a first BS (e.g., a serving BS) receives from the remote UE measurements. The remote UE is communicating with the first BS via an indirect path that includes a first SL between the remote UE and a first relay UE or a direct path between the remote UE and the first BS. A communication method is selected based on the measurements. The communication method includes one of 1) the remote UE communicating with a second BS (e.g., a target BS) using the direct path between the remote UE and the second BS; 2) the remote UE communicating with the second BS using the indirect path between the remote UE and the second BS, the indirect path including a second SL between the remote UE and a second relay UE; or 3) the remote UE communicating with the second BS using both the direct path and the indirect path.

In some arrangements, a first BS (source BS) sends to a second BS (target BS) a handover request including a target cell ID. A remote UE is communicating with the first BS via a first indirect path including a first SL between the remote UE and a first relay UE or a first direct path between the remote UE and the first BS. The target cell ID includes an ID of a serving cell (e.g., serving cell ID or NCGI) of a second relay UE or a serving cell of the direct path. The first BS receives from the second BS a handover response.

In some arrangements, a first UE (e.g., a remote UE) receives from a BS via a direct path, an ID of a second UE (e.g., a relay UE) and channel configuration for a SL communication channel between the first UE and the second UE. The first UE establish with the second UE the SL communication channel using the ID of the second UE and the channel configuration.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication network, according to various arrangements.

FIG. 1B is a diagram illustrating a block diagram of an example wireless communication system for transmitting and receiving downlink, uplink, and/or SL communication signals, according to various arrangements.

FIG. 2 illustrates an example scenario for SL communication, according to various arrangements.

FIG. 3 is a diagram illustrating a handover method, according to various arrangements.

FIG. 4 is a diagram illustrating a handover method, according to various arrangements.

FIG. 5 is a diagram illustrating a handover method, according to various arrangements.

FIG. 6 is a diagram illustrating an example method for adding an indirect path in addition to a direct path, according to various arrangements.

FIG. 7A is a diagram illustrating an example intra-cell multi-path scenario, according to various arrangements.

FIG. 7B is a diagram illustrating an example inter-cell multi-path scenario, according to various arrangements.

FIG. 8 is a flowchart diagram illustrating an example method for managing SL communications, according to various arrangements.

FIG. 9 is a flowchart diagram illustrating an example method for managing SL communications, according to various arrangements.

FIG. 10 is a flowchart diagram illustrating an example method for managing SL communications, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

This arrangements relate to New Radio (NR) SL relay communications, and in particular, to SL UE-to-Network relay path switching with single path or multiple paths. For example, some arrangements relate to negotiating path switching configuration between source gNB and target gNB for a remote UE. Some arrangements relate to triggering a RRC idle/inactive relay UE enter into RRC connected state during indirect path addition for multi-path communication. In some arrangements, emergency-only services for remote UE is ensured.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional BS-centric cellular networks have limited high data rate capabilities and support for proximity services. In this context, device-to-device (D2D) communications emerge to address the shortcomings of the BS-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSe), unilateral/sidechain/SL communication, and so on.

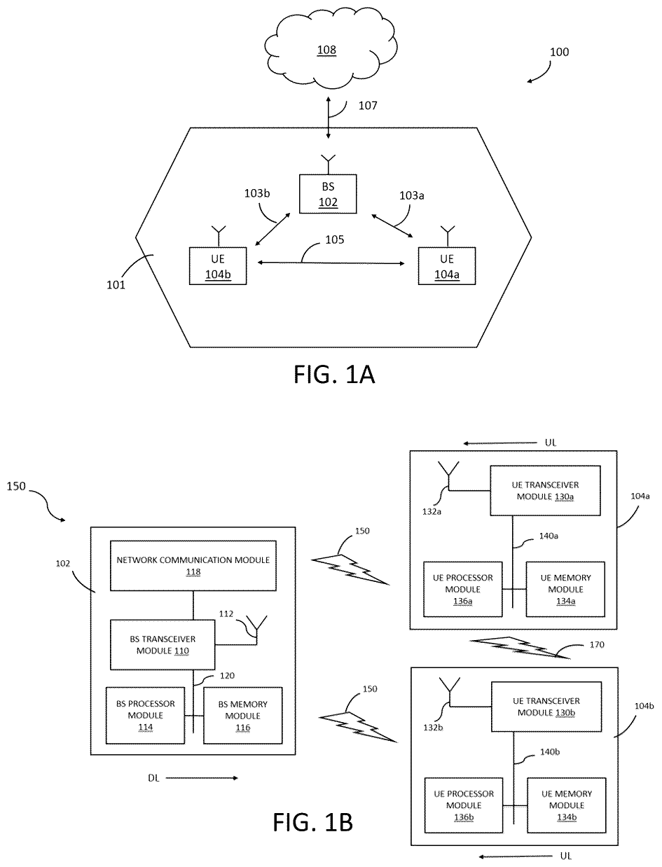

Referring to FIG. 1A, an example wireless communication system 100 is shown. The wireless communication system 100 illustrates a group communication within a cellular network. In a wireless communication system, a network side communication node or a BS can include a next Generation Node B (gNB), an E-UTRAN Node B (also known as Evolved Node B, eNodeB or eNB), a pico station, a femto station, a Transmission/Reception Point (TRP), an Access Point (AP), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In FIG. 1A, a network side and a terminal side communication node are represented by a BS 102 and UEs 104a and 104b, respectively. In some arrangements, the BS 102 and UEs 104a/104b are sometimes referred to as “wireless communication node” and “wireless communication device,” respectively. Such communication nodes/devices can perform wireless communications.

In FIG. 1A, the BS 102 can define a cell 101 in which the UEs 104a and 104b are located. The UEs 104a and/or 104b can be moving or remain stationary within a coverage of the cell 101. The UE 104a can communicate with the BS 102 via a communication channel 103a. Similarly, the UE 104b can communicate with the BS 102 via a communication channel 103b. In addition, the UEs 104a and 104b can communicate with each other via a communication channel 105. The communication channels 103a and 103b between a respective UE and the BS can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, vehicle network communications modes can be collective referred to as Vehicle-to-Everything (V2X) communications. The BS 102 is connected to Core Network (CN) 108 through an external interface 107, e.g., an Iu interface.

For supporting applications and services in a broader scope (e.g., in indoor relay communications, smart agriculture, smart factories, public security, and so on), SL-based relay communications can be used to extend the coverage and improve the power consumption. In FIG. 1A, the remote UE (e.g., the UE 104b) may be in an area with weak or no coverage from the BS. Thus, the remote UE (e.g., the UE 104b) that does not directly communicate with the BS 102 or the CN 108 and communicates indirectly with the BS 102 and the CN 108 using the SL communication channel 105 via a relay UE (e.g., the UE 104a), which can directly communicate with the BS 102 and the CN 108 or indirectly communicate with the BS 102 and the CN 108 via at least one other relay UE that can directly communicate with the BS 102 and the CN 108. As a result, the coverage of the network is extended and the capacity of the network is enlarged. The UE 104a is referred to as a U2N relay and the UE 104b is referred to as the remote UE. On the other hand, if the remote UE 104b is in coverage, the remote UE 104b can be switched to the direct path, e.g., the a communication channel 103a. In addition, the multi-path relay can be supported. For example, the in-coverage remote UE 104b is connected to CN 108 via both a direct path (data directly transmitted between remote UE and network via the communication channel 103a) and an indirect path (data forwarded via relay UE 104a via the communication channels 103b and 105), thus improving the reliability/robustness as well as throughput.

FIG. 1B illustrates a block diagram of an example wireless communication system for transmitting and receiving downlink, uplink and SL communication signals, in accordance with some arrangements of the present disclosure. In some arrangements, the system can transmit and receive data in a wireless communication environment such as the wireless communication system 100 of FIG. 1A, as described above.

The system generally includes the BS 102 and UEs 104a and 104b, as described in FIG. 1A. The BS 102 includes a BS transceiver module 110, a BS antenna 112, a BS memory module 116, a BS processor module 114, and a network communication module 118, each module being coupled and interconnected with one another as necessary via a data communication bus 120. The UE 104a includes a UE transceiver module 130a, a UE antenna 132a, a UE memory module 134a, and a UE processor module 136a, each module being coupled and interconnected with one another as necessary via a data communication bus 140a. Similarly, the UE 104b includes a UE transceiver module 130b, a UE antenna 132b, a UE memory module 134b, and a UE processor module 136b, each module being coupled and interconnected with one another as necessary via a data communication bus 140b. The BS 102 communicates with the UEs 104a and 104b via one or more of a communication channel 150, which can be any wireless channel or other medium known in the art suitable for transmission of data as described herein.

The system may further include any number of modules other than the modules shown in FIG. 1B. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a and 104b to an antenna of the BS 102 is known as an uplink transmission, and a wireless transmission from an antenna of the BS 102 to an antenna of one of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter and receiver circuitry that are each coupled to the respective antenna 132a and 132b. A duplex switch may alternatively couple the uplink transmitter or receiver to the uplink antenna in time duplex fashion. Similarly, the BS transceiver module 110 may be herein referred to as a downlink transceiver, or BS transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 150 at the same time that the downlink transmitter is coupled to the antenna 112. In some arrangements, the UEs 104a and 104b can use the UE transceivers 130a and 130b through the respective antennas 132a and 132b to communicate with the BS 102 via the wireless communication channel 150. The wireless communication channel 150 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the BS transceiver 110 are configured to communicate via the wireless data communication channel 150, and cooperate with a suitably configured antenna arrangement that can support a particular wireless communication protocol and modulation scheme. In some arrangements, the UE transceiver 130a and 130b and the BS transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the BS transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein may be embodied directly in hardware, in firmware, in a software module executed by processor modules 114 and 136a and 136b, respectively, or in any practical combination thereof. The memory modules 116 and 134a and 134b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b may be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 116, 134a, and 134b, respectively. Memory modules 116, 134a, and 134b may also each include non-volatile memory for storing instructions to be executed by the processor modules 114 and 136a and 136b, respectively.

The network interface 118 generally represents the hardware, software, firmware, processing logic, and/or other components of the BS 102 that enable bi-directional communication between BS transceiver 110 and other network components and communication nodes configured to communication with the BS 102. For example, the network interface 118 may be configured to support internet or WiMAX traffic. In a typical deployment, without limitation, the network interface 118 provides an 802.3 Ethernet interface such that BS transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the BS 102 to communicate with other BSs or core network over a wired or wireless connection.

In some arrangements, each of the UEs 104a and 104b can operate in a hybrid communication network in which the UE communicates with the BS 102, and with other UEs, e.g., between 104a and 104b. As described in further detail below, the UEs 104a and 104b support SL communications with other UE's as well as downlink/uplink communications between the BS 102 and the UEs 104a and 104b. In general, the SL communication allows the UEs 104a and 104b to establish a direct communication link with each other, or with other UEs from different cells, without requiring the BS 102 to relay data between UEs.

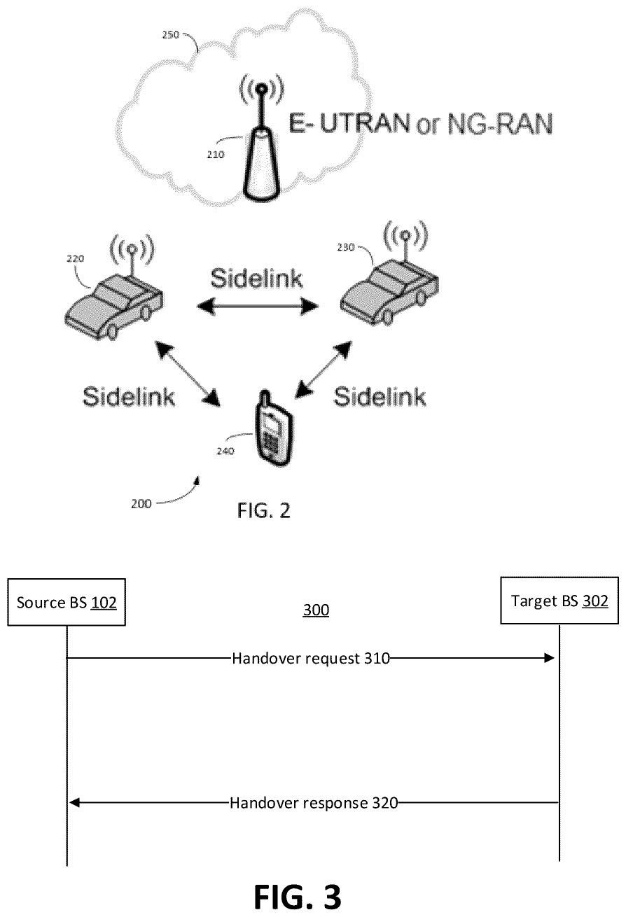

FIG. 2 is a diagram illustrating an example system 200 for SL communication, according to various arrangements. As shown in FIG. 2, a BS 210 (such as BS 102 of FIG. 1A) broadcasts a signal that is received by a first UE 220, a second UE 230, and a third UE 240. The UEs 220 and 230 in FIG. 2 are shown as vehicles with vehicular communication networks, while the UE 240 is shown as a mobile device. As shown by the SLs, the UEs 220-240 are able to communicate with each other (e.g., directly transmitting and receiving) via an air interface without forwarding by the base station 210 or the core network 250. This type of V2X communication is referred to as PC5-based V2X communication or V2X SL communication.

As used herein, when two UEs 104a or 104b are in SL communications with each other via the communication channel 105/170, the UE that is transmitting data to the other UE is referred to as the transmission (TX) UE, and the UE that is receiving said data is referred to as the reception (RX) UE.

The arrangements disclosed herein relate to systems, methods, apparatuses, and non-transitory computer-readable media for SL relay communications, and in particular, to improving service continuity assurance for a UE with multi-path transmission/reception in a network by providing the UE with path switching

In some implementations (e.g., R17 SL relay), the Uu measurement configuration and measurement report signaling procedures are performed to evaluate both relay link measurement (e.g., over the communication channel 105) and Uu link measurement (e.g., over the communication channels 103a and 103b). The measurement results from L2 U2N remote UE 104b are reported in response to determining that the configured measurement reporting criteria are met. Similarly, the Uu measurement for signaling procedures are used for R18 inter-gNB path switch cases. The measurement results from L2 U2N remote UE 104b may include at least one of: serving Uu link measurement results, serving SL relay link measurement results (e.g., measuring the PC5 link quality between the remote UE 104b and its serving relay UE 104a), intra-BS Uu measurement results (e.g., measuring the signal strength of a neighbor Uu cell of the serving BS 102), intra-BS (e.g., intra gNB) SL relay link measurement results (e.g., measuring the PC5 link signal strength between the remote UE 104b and a candidate relay UE of the serving BS 102), inter-BS Uu measurement results (measuring signal strength of a neighbor Uu cell of a neighbor BS), inter-BS SL relay link measurement results (measuring PC5 link signal strength between the remote UE 104b and a candidate relay UE of a neighbor BS). The intra-BS or inter-BS SL relay link measurement results may include a list of candidate relay UEs, where information provided for each candidate relay UE in the list includes at least one of: a relay UE ID, relay UE's serving cell ID, PC5 link signal strength between the remote UE and the relay UE.

In some arrangements, after receiving measurement results from the L2 U2N remote UE 104b, the source BS 102 can determine to switch the remote UE 104b to a direct Uu link or path of a target BS, an indirect link or path of a target BS, or switch to a target BS with both direct Uu link and indirect link (e.g., multi-path). In some examples, the source BS selects to switch the remote UE 104b to a single path of a target BS (e.g., a direct path or an indirect path) or multiple paths (e.g., both the direct and the indirect paths) of a target BS.

In some examples, the source BS 102 selects to switch the remote UE 104b to a direct path between the target BS and the remote UE 104b, and the source BS 102 selects the target BS (e.g., the target cell).

In some examples in which the source BS 102 selects to switch the remote UE 104b to an indirect path between the target BS and the remote UE 104b, and the source BS 102 selects the target relay UE and sends the identity of the target relay UE to the target BS, or the source BS 102 provides multiple candidate relay UEs (who are in coverage of the target BS) to the target BS for the target BS to select the target relay UE.

In some examples in which the source BS 102 selects to switch the remote UE 104b to multiple paths (e.g., both the direct and the indirect paths), the source BS 102 can provide the selected target cell ID and target relay UE to target BS or provide the selected target cell ID and a list of candidate relay UEs to the target BS.

In some examples, the source BS 102 provides information described herein to the target BS via a handover request message. FIG. 3 is a diagram illustrating a handover method 300, according to various arrangements. At 310, the source BS 102 sends a handover request 310 to the target BS 302. At 320, the source BS 102 receives from the target BS 302 a handover response 320 in response to receiving the handover request 310.

In some examples, the handover request message (e.g., sent at 310) includes the target cell ID (e.g., the target Uu cell ID) that identifies the target cell. In the examples in which a single path at the target BS 302 is selected, the target cell ID includes the serving cell ID/Cell Global Identifier (NCGI) of the selected target relay UE or the service cell ID/NCGI of one or more of the candidate relay UE(s). In some examples, the target cell ID is the selected target cell of the direct path of the multi-path instead of the serving cell of target/candidate relay UE.

In some examples, in which both the target cell ID and a list of candidate relay UEs are included in the handover request message, clarity needs to be provided to the target BS 302 as to whether the source BS 102 intends to perform a path switch (switch to a single path) or use multi-path for the remote UE 104b. Accordingly, the source BS 102 further indicates to the target BS 302 the path switch type via a path switching indication, which may include at least one of a single path switch (indicates to switch to an indirect path), indirect path (indicates to switch to an indirect path), multiple paths (indicates to switch to multiple paths), path addition (indicates to switch to multiple paths), direct-to-indirect path switch, indirect-to-indirect path switch, single-to-multi-path switch, direct-to-multi-path switch, indirect-to-multi-path switch, multi-path to multi-path switch.

For switching to multi-path, the source BS 102 can identify the primary path (direct path or indirect path) and send the primary path indication to target BS 302 (e.g., via the handover request message at 310). In some examples, the target BS 302 can determine the primary path and inform the source BS 102 using the primary path indication (e.g., via the handover response or handover request acknowledgement message at 320).

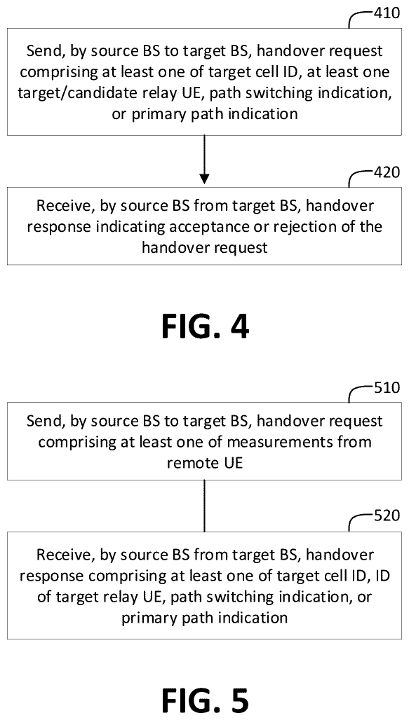

FIG. 4 is a diagram illustrating a handover method 400, according to various arrangements. At 410, the source BS 102 sends a handover request 310 to the target BS 302, the handover request includes at least one of a target cell ID (e.g., a target Uu cell ID), an ID for a target relay UE, an ID for each of two or more candidate relay UEs, a path switching indication, or a primary path indication. At 420, the source BS 102 receives from the target BS 302 a handover response 320 in response to receiving the handover request 310. The handover response indicates acceptance or rejection of the handover request.

In some arrangements, after receiving measurement results from the L2 U2N remote UE 104b, the source BS 102 can select a target BS for the remote UE 104b, then the target BS can determine to configure the remote UE 104b with a single direct Uu link, an indirect link, or multi-path.

The source BS 102 can provide the measurement results (related to the selected target BS) from the remote UE 104b to the target BS 302, and then the target BS 392 can configure the remote UE 104b with a single direct Uu link (e.g., the target BS 302 further selects the target cell), indirect link (e.g., the target BS 302 further selects the target relay UE), or multiple paths (e.g., the target BS 302 selects the target Uu cell of the direct path and the target relay UE of the indirect path of the multiple paths). The target BS 302 can inform the source BS 102 at least one of: for single path, the target Uu cell ID and the target relay UE ID; for the multi-path, the target Uu cell ID and the target relay UE ID of multi-path, and primary path indication (direct path or indirect path if multi-path is configured).

FIG. 5 is a diagram illustrating a handover method 500, according to various arrangements. At 510, the source BS 102 sends a handover request 310 to the target BS 302, the handover request includes measurements received from the remote UE 104b. At 520, the source BS 102 receives from the target BS 302 a handover response 320 in response to receiving the handover request 310. The handover response includes at least one of a target cell ID (e.g., a target Uu cell ID), ID of a target relay UE, a path switching indication, or a primary path indication.

In CU-DU split implementations, the BS-CU (e.g., gNB-CU) can inform the BS-DU (e.g., gNB-DU) over the F1 interface at least one of path switch type information or primary path indication. In some examples, the source BS 102 includes a CU and a DU. The CU of the source BS 102 can determine at least one of the path switch type or the primary path indication in the manner described herein and send the same to the DU of the source BS 102 via the F1 interface. In some examples, the target BS 302 includes a CU and a DU. The CU of the target BS 302 can determine at least one of the path switch type or the primary path indication and send the same to the DU of the target BS 302 via the F1 interface.

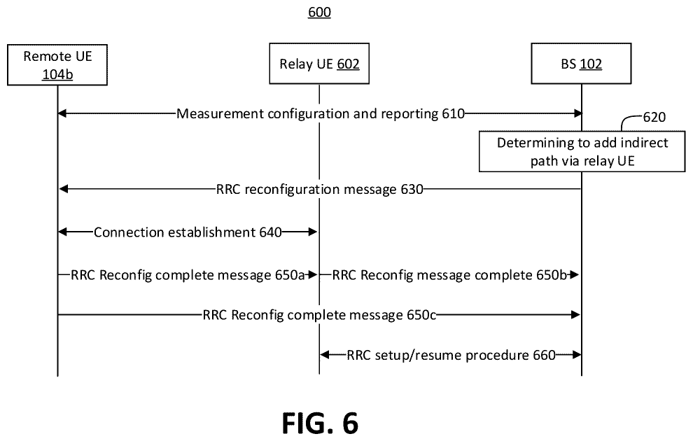

In some arrangements, the multi-path configuration can trigger a relay UE in the idle/inactive mode to enter into connected mode. A L2 U2N remote UE 104b can connect to the CN 108 via direct path to the BS 102 initially, and an indirect path from the remote UE 104b to the BS 102 can be added. FIG. 6 is a diagram illustrating an example method 600 for adding an indirect path in addition to a direct path, according to various arrangements. The relay UE 602 can be the UE 104a before the communication channel 105 is established. The method 600 seeks to establish the communication channel 105 in addition to the communication link 103b.

At 610, the remote UE 104b (e.g., the U2N remote UE) reports one or multiple candidate relay UEs (e.g., at least one U2N Relay UE) after the remote UE 104b measures/discovers the at least one candidate relay UE. At 620, the BS 102 determines to add an indirect path for the remote UE 104b via the relay UE 602, the relay UE 602 is one of the at least one candidate relay UE. In some examples, the relay UE 602 is in RRC idle/inactive state. The BS 102 sends an RRC reconfiguration message (e.g., RRCReconfiguration message) to the remote UE 104b, at 630. The RRC reconfiguration message can include at least U2N relay UE ID (e.g., the ID of the relay UE 602), PC5 relay RLC channel configuration for relay traffic and the associated indirect/split bearer configuration for the SL communication channel 105 between the remote UE 104b and the relay UE 602, and so on. The remote UE 104b establishes PC5 connection with the relay UE 602 at 640, using the relay UE ID and the relay RLC channel configuration.

In addition, the remote UE 104b sends the RRC reconfiguration complete message to the BS 102. In some examples, the remote UE 104b can send the RRC reconfiguration complete message via an indirect path (including 650a and 650b). That is, the remote UE 104b sends the RRC reconfiguration message to the relay UE 602 at 650a, and the relay UE 602 sends the RRC reconfiguration message to the BS 102 at 650b. Alternatively, the remote UE 104b can send the RRC reconfiguration complete message via a direct path (650c). That is, the remote UE 104b sends the RRC reconfiguration message to the BS 102 directly at 650c. In the example in which the relay UE 602 is in the RRC idle/inactive state, the BS 102 triggers the relay UE 602 to enter into the RRC connected state to support the multi-path transmission/reception of the remote UE 104b.

In some arrangements, the BS 102 can indicate or configure the remote UE 104b to send the RRC reconfiguration complete message via the indirect path (e.g., 650a and 650b) or the direct path (e.g., 650c). Such indication information can be included in the RRC reconfiguration message 630. In some examples, the indication information includes one of SRB1 via direct path or SRB1 via indirect path. In response to the remote UE 104b receiving SRB1 via the direct path between the remote UE 104b and the BS 102, the remote UE 104b sends the RRC reconfiguration complete message via the direct path. In response to the remote UE 104b receiving SRB1 via the indirect path between the remote UE 104b and the BS 102, the remote UE 104b sends the RRC reconfiguration complete message via the indirect path.

In the examples in which the remote UE 104b is configured to send RRC reconfiguration complete message via the indirect path (SL communication channel), in response to receiving the RRC reconfiguration complete message from the remote UE 104b, the relay UE 602 is triggered to enter into the RRC connected state and forward the RRC reconfiguration complete message to the BS 102.

In the examples in which the remote UE 104b is configured to send RRC reconfiguration complete message via the direct path, the relay UE 602 is triggered to enter into the RRC connected state in response to receiving trigger indication from the remote UE at 640. That is, after receiving PC5 link setup request message or PC5 RRC reconfiguration message or other PC5 messages from the remote UE 104b including trigger indication, the relay UE 602 becomes aware that the relay UE 602 initiates RRC setup/resume procedure to enter into the RRC connected state. In this case, the remote UE 104b can send the indication to the relay UE 602 to trigger the relay UE to enter into the RRC connected state. The indication information can include at least one of: a multi-path indication, a path addition indication, a relay communication indication, a go-into-RRC connected-state indication, a trigger of enter into RRC connected state, or so on.

In some examples in which the remote UE 104b is initially connected to the CN 108 via direct path initially and the indirect path is added according to the method 600. After a while, the measurement results of the indirect path is no longer acceptable and/or the Quality of Service (QoS) flow for the remote UE 104b does not require the multi-path transmission on the indirect path. In this case, the BS 102 may the release the indirect path. Considering that the remote UE 104b is initially connected to the CN 108 via the direct path, the Cell Radio Network Temporary Identifier (C-RNTI) is allocated by the cell via the direct path. This cell is also regarded by the remote UE 104b as a Primary Secondary Cell (PScell). The release of the indirect path does not impact the Primary Cell (PCell) and the corresponding C-RNTI. On the other hand, in the examples in which the remote UE is initially connect to the network via the indirect path and the direct path is added. The cell of indirect path is regarded as the PCell and the C-RNTI is also allocated by the PCell. During the release of indirect path, the PCell of the remote UE 104b is changed to the cell of direct path. In this case, a C-RNTI allocated by the cell of direct path is configured to the remote UE 104b by the BS 102. This can be configured during the indirect path release procedure or allocated in response to adding the direct path.

In some examples in which the serving cells of direct and indirect paths belong to the same DU, only one C-RNTI needs to be allocated. In the examples in which the serving cells of direct and indirect paths belong to different DUs, two C-RNTIs may be allocated to the remote UE 104b. In response to adding the new path for the remote UE 104b, whether a new C-RNTI will be allocated to the remote UE 104b depends on the whether new serving cell belong to another DU is associated with the newly added path. Correspondingly, the release of a given path may remove the C-RNTI if the path is associated with a different DU. Otherwise, only the path and corresponding cell is removed, the C-RNTI remains.

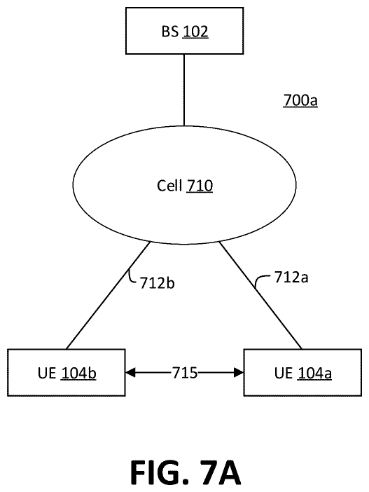

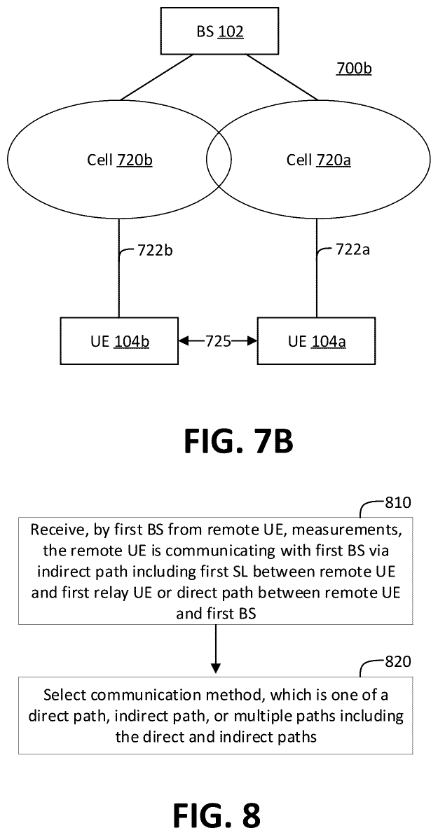

FIG. 7A is a diagram illustrating an example intra-cell multi-path scenario 700a, according to various arrangements. The BS 102 can provide coverage within a cell 710. The UE 104a and 104b can be camped within the cell 710. The remote UE 104b can access the cell 710 and the BS 102 directly via direct path including the communication channel 712b. The remote UE 104b can also access the cell 710 and the BS 102 indirectly via SL communication channel 715 and the communication channel 712a. The SL communication channel 715 can be referred to as a PC5 or internal connection. The UE 104b can be connected to the BS 102 via intra-cell multi-path communications.

FIG. 7B is a diagram illustrating an example inter-cell multi-path scenario 700b, according to various arrangements. The BS 102 can provide coverage within cells 710a and 720b. The UE 104a can be camped within the cell 720a. The UE 104b can be camped within the cell 720b. The remote UE 104b can access the cell 720b and the BS 102 directly via direct path including the communication channel 722b. The remote UE 104b can also access the cell 720a and the BS 102 indirectly via SL communication channel 725 and the communication channel 722a. The SL communication channel 725 can be referred to as a PC5 or internal connection. The UE 104b can be connected to the BS 102 via inter-cell multi-path communications.

In some arrangements, emergency service is defined as citizen to authority services, and it is left to the national authorities to decide whether the network accepts emergency calls, e.g., for valid UEs only, or for UEs without the Subscriber Identity Module (SIM), Universal Subscriber Identity Module (USIM), Internet Protocol (IP) Multimedia Services Identity Module (ISIM). In the 5G ProSe UE-to-Network relaying, an emergency request from the remote UE 104b implies that the relay UE 602 needs to be responsible for the emergency service of the remote UE 104b.

The relay UE 602 ensures that the traffic and the signaling of the 5G ProSe Layer-2 remote UE 104b are related to the emergency service when the Connection Establishment for 5G ProSe Layer-2 UE-to-Network Relay is used for emergency service, especially when the 5G ProSe Layer-2 UE-to-Network Relay is under congestion control, mobility restriction. To ensure that the traffic and the signaling of the 5G ProSe Layer-2 Remote UE (e.g., the UE 104b) are related to the emergency service, the Radio Access Network (RAN) (e.g., the BS) can notify the Access and Mobility Management Function (AMF) of the remote UE 104b that the remote UE 104b is only allowed to perform the emergency services. In some examples, the notification information can include at least one of: emergency service indication, indication of emergency-only service is allowed, resource limitation indication, remote UE indication, or so on. The notification information can be send from the BS to the AMF via an initial UE message, UE context setup/modification response message, RAN configuration update message, or a new NG Application Protocol (NGAP) message.

FIG. 8 is a flowchart diagram illustrating an example method 800 for managing SL communications, according to various arrangements. At 810, a first BS (e.g., a serving BS) receives from the remote UE measurements. The remote UE is communicating with the first BS via an indirect path that includes a first SL between the remote UE and a first relay UE or a direct path between the remote UE and the first BS. At 820, a communication method is selected based on the measurements. The communication method includes one of 1) the remote UE communicating with a second BS (e.g., a target BS) using the direct path between the remote UE and the second BS; 2) the remote UE communicating with the second BS using the indirect path between the remote UE and the second BS, the indirect path including a second SL between the remote UE and a second relay UE; or 3) the remote UE communicating with the second BS using both the direct path and the indirect path.

In some examples, selecting the communication method 800 includes selecting, by the first BS based on the measurements, the communication method.

In some examples, selecting the communication method includes selecting, by the first BS, the second BS and selecting, by the second BS based on the measurements, the communication method. The method further includes sending, by the first BS to the second BS, a handover request, the handover request includes the measurements received from the remote wireless communication device, and receiving, by the first BS from the second BS, a handover response. The handover response includes at least one of: 1) a target cell ID, the target cell ID including an ID of a serving cell (e.g., a serving cell ID or NCGI) of the second relay UE or the ID of a serving cell of the direct path; 2) an ID of the second relay UE; 3) a path switching indication indicating a path switch type of single path or multiple paths; or 4) a primary path indication indicating one of direct path or the indirect path as a primary path.

In some arrangements, the method 800 includes determining, by a CU of a BS, a path switch type and sending, by the CU of the BS to a DU of the BS, the path switch type. The BS is the first BS or the second BS.

In some arrangements, the measurements includes at least one of serving Uu link measurement results, serving SL relay link measurement results, intra-BS Uu measurement results, intra-BS SL relay link measurement results, inter-BS Uu measurement results, or inter-BS SL relay link measurement results.

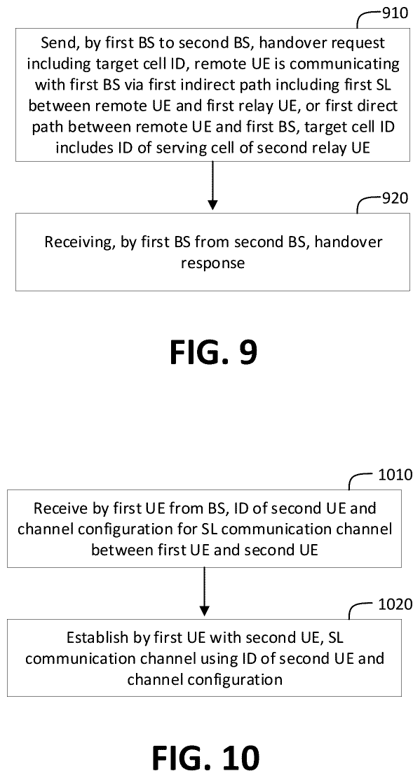

FIG. 9 is a flowchart diagram illustrating an example method 900 for managing SL communications, according to various arrangements. At 910, a first BS (source BS) sends to a second BS (target BS) a handover request including a target cell ID. A remote UE is communicating with the first BS via a first indirect path including a first SL between the remote UE and a first relay UE or a first direct path between the remote UE and the first BS. The target cell ID includes an ID of a serving cell (e.g., serving cell ID or NCGI) of a second relay UE or a serving cell of the direct path. At 920, the first BS receives from the second BS a handover response.

In some examples, the handover request further includes a list of candidate relay UEs and a path switching indication. The path switching indication indicates at least one of a path switch type including a single path, an indirect path, multiple paths, path addition, direct-to-indirect path switch, indirect-to-indirect path switch, single-to-multi-path switch, direct-to-multi-path switch, indirect-to-multi-path switch, or multi-path to multi-path switch. In some examples, the second BS selects a target relay UE from the second relay UE and the list of candidate relay UEs. The target relay UE is identified in the handover response.

The handover request further includes a primary path indication indicating one of a second direct path between the remote UE and the second BS or a second indirect path including a second SL between the remote UE and the second relay UE as a primary path. The handover response includes the primary path indication indicating the one of the second direct path or the second indirect path as the primary path.

FIG. 10 is a flowchart diagram illustrating an example method 1000 for managing SL communications, according to various arrangements. At 1010, a first UE (e.g., a remote UE) receives from a BS via a direct path, an ID of a second UE (e.g., a relay UE) and channel configuration for a SL communication channel between the first UE and the second UE. At 1020, the first UE establish with the second UE the SL communication channel using the ID of the second UE and the channel configuration.

In some examples, the ID of the second UE and the channel configuration are received by the first UE in a RRC reconfiguration message. The method 1000 includes sending, by the first UE to the BS, an RRC reconfiguration complete message via the direct path or an indirect path including the SL communication channel.

In some examples, the first UE receives indication information indicating whether the RRC reconfiguration complete message is to be sent via the direct path or an indirect path including the SL communication channel.

In some examples, the first UE sends to the second UE indication information triggering the second UE to enter into a RRC connected state. The indication information includes at least one of a multi-path indication, a path addition indication, a relay communication indication, a go-into-RRC connected-state indication, or a trigger to enter into RRC connected state.

In some examples, after the SL communication channel is established, the original or initial direct path is released (e.g., due to poor link quality, and so on). Thereafter, if Uu link is satisfied and high throughput, high reliability, low latency or high QoS service is required, a direct path between the first UE and the BS is added after the SL communication channel is established. In some examples, the first UE receives from the BS a C-RNTI of a cell corresponding to the direct path during a release procedure for releasing an indirect path including the SL communication channel or during the direct path addition procedure.

In some examples, the method 1000 further includes communicating by the first UE with a CU of the BS using a direct path corresponding to a first DU and adding an indirect path corresponding to a second DU, the indirect path includes the SL communication channel and allocating, by the second DU for the first UE, a C-RNTI corresponding to the indirect path, when the first DU and the second DU are different. In some examples, the method 1000 further includes communicating by the first UE with a CU of the BS using an indirect path corresponding to a first DU and adding a direct path corresponding to a second DU. The indirect path includes the SL communication channel and allocating, by the second DU for the first UE, a C-RNTI corresponding to the indirect path, when the first DU and the second DU are different.

In some examples, the method 1000 further includes communicating by the first UE with the CU using a direct path corresponding to a first DU and an indirect path corresponding to a second DU, the indirect path includes the SL communication channel. The method 1000 further includes releasing, by the BS for the first UE, one of the direct path or the indirect path, and removing, by the BS for the first UE, a C-RNTI corresponding to the one of the direct path or the indirect path in response to determining that the first DU and the second DU are different.

In some examples, the method 1000 further includes sending, by the BS to an AMF of the first UE, notification information indicating that the AMF is allowed to provide emergency-only services for the first UE, the notification information includes one of an emergency service indication, indication that emergency-only service is allowed, resource limitation indication, or remote UE indication.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
receiving, by a first Base Station (BS) from a remote wireless communication device, measurements, wherein the remote wireless communication device is communicating with the first BS via an indirect path comprising a first Sidelink (SL) between the remote wireless communication device and a first relay wireless communication device or a direct path between the remote wireless communication device and the first BS; and
selecting, based on the measurements, a communication method comprising one of:
the remote wireless communication device communicating with a second BS using the direct path between the remote wireless communication device and the second BS;
the remote wireless communication device communicating with the second BS using the indirect path between the remote wireless communication device and the second BS, the indirect path comprising a second SL between the remote wireless communication device and a second relay wireless communication device; or
the remote wireless communication device communicating with the second BS using both the direct path and the indirect path.

2. The wireless communication method of claim 1, comprising
determining, by a Centralized Unit (CU) of a BS, a path switch type; and
sending, by the CU of the BS to a Distributed Unit (DU) of the BS, a path switch type, wherein the BS is the first BS or the second BS.

3. The wireless communication method of claim 2, wherein the path switch type comprises a path addition indication.

4. The wireless communication method of claim 1, wherein the measurements comprise at least one of:
serving Uu link measurement results;
serving SL relay link measurement results;
intra-BS Uu measurement results;
intra-BS SL relay link measurement results;
inter-BS Uu measurement results; or
inter-BS SL relay link measurement results.

5. A first base station (BS), comprising:
at least one processor configured to:
receive, via a receiver from a remote wireless communication device, measurements, wherein the remote wireless communication device is communicating with the first BS via an indirect path comprising a first Sidelink (SL) between the remote wireless communication device and a first relay wireless communication device or a direct path between the remote wireless communication device and the first BS; and
select, based on the measurements, a communication method comprising one of:
the remote wireless communication device communicating with a second BS using the direct path between the remote wireless communication device and the second BS;
the remote wireless communication device communicating with the second BS using the indirect path between the remote wireless communication device and the second BS, the indirect path comprising a second SL between the remote wireless communication device and a second relay wireless communication device; or
the remote wireless communication device communicating with the second BS using both the direct path and the indirect path.

6. The first BS of claim 5, wherein:
a Centralized Unit (CU) of a BS determines a path switch type, and sends a path switch type to a Distributed Unit (DU) of the BS, wherein the BS is the first BS or the second BS.

7. The first BS of claim 6, wherein the path switch type comprises a path addition indication.

8. The BS of claim 5, wherein the measurements comprise at least one of:
serving Uu link measurement results;
serving SL relay link measurement results;
intra-BS Uu measurement results;
intra-BS SL relay link measurement results;
inter-BS Uu measurement results; or
inter-BS SL relay link measurement results.

9. A wireless communication method, comprising:
transmitting, by a remote wireless communication device to a first Base Station (BS), measurements, wherein the remote wireless communication device is communicating with the first BS via an indirect path comprising a first Sidelink (SL) between the remote wireless communication device and a first relay wireless communication device or a direct path between the remote wireless communication device and the first BS,
wherein a communication method is selected based on the measurements, the communication method comprising one of:
the remote wireless communication device communicating with a second BS using the direct path between the remote wireless communication device and the second BS;
the remote wireless communication device communicating with the second BS using the indirect path between the remote wireless communication device and the second BS, the indirect path comprising a second SL between the remote wireless communication device and a second relay wireless communication device; or
the remote wireless communication device communicating with the second BS using both the direct path and the indirect path.

10. The wireless communication method of claim 9, wherein:
a Centralized Unit (CU) of a BS determines a path switch type, and send, via a transmitter to a Distributed Unit (DU) of the BS, a path switch type, wherein the BS is the first BS or the second BS.

11. The wireless communication method of claim 10, wherein the path switch type comprises a path addition indication.

12. The wireless communication method of claim 9, wherein the measurements comprise at least one of:
serving Uu link measurement results;
serving SL relay link measurement results;
intra-BS Uu measurement results;
intra-BS SL relay link measurement results;
inter-BS Uu measurement results; or
inter-BS SL relay link measurement results.

13. A remote wireless communication device, comprising:
at least one processor configured to:
transmit, via a transmitter to a first Base Station (BS), measurements, wherein the remote wireless communication device is communicating with the first BS via an indirect path comprising a first Sidelink (SL) between the remote wireless communication device and a first relay wireless communication device or a direct path between the remote wireless communication device and the first BS,
wherein a communication method is selected based on the measurements, the communication method comprising one of:
the remote wireless communication device communicating with a second BS using the direct path between the remote wireless communication device and the second BS;
the remote wireless communication device communicating with the second BS using the indirect path between the remote wireless communication device and the second BS, the indirect path comprising a second SL between the remote wireless communication device and a second relay wireless communication device; or
the remote wireless communication device communicating with the second BS using both the direct path and the indirect path.

14. The wireless communication method of claim 13, wherein:
a Centralized Unit (CU) of a BS determines a path switch type, and sends, via a transmitter to a Distributed Unit (DU) of the BS, a path switch type, wherein the BS is the first BS or the second BS.

15. The wireless communication method of claim 14, wherein the path switch type comprises a path addition indication.

16. The wireless communication method of claim 13, wherein the measurements comprise at least one of:
serving Uu link measurement results;
serving SL relay link measurement results;
intra-BS Uu measurement results;
intra-BS SL relay link measurement results;
inter-BS Uu measurement results; or
inter-BS SL relay link measurement results.

17. A non-transitory computer readable medium, storing code, which when executed by at least one processor, causes the at least one processor to perform the wireless communication method of claim 1.

18. A non-transitory computer readable medium, storing code, which when executed by at least one processor, causes the at least one processor to perform the wireless communication method of claim 5.
